(19) United States
(12) Patent Application Publication
(10) Pub. No.: US 2026/0269309 A1
(43) Pub. Date: Sep. 10, 2026

(54) METHOD OF MAKING LITHIUM LANTHANUM ZIRCONIUM OXIDE FILMS AND SOLID-STATE LITHIUM-BASED BATTERIES CONTAINING THE SAME

(71) Applicant: Ensurge Micropower ASA, Oslo (NO)

(72) Inventor: Zhongchun WANG, San Jose, CA (US)

(73) Assignee: Ensurge Micropower ASA, Oslo (NO)

(21) Appl. No.: 19/444,254

(22) Filed: Jan. 9, 2026

Related U.S. Application Data
(60) Provisional application No. 63/750,738, filed on Jan. 28, 2025.

(51) Int. Cl. H01M 10/0562; H01M 4/02; H01M 4/04; H01M 4/505; H01M 4/525

(52) U.S. Cl. CPC H01M 10/0562; H01M 4/0407; H01M 4/505; H01M 4/525; H01M 2004/021; H01M 2004/028; H01M 2300/0077

(57) ABSTRACT

Methods of making a lithium lanthanum zirconium oxide (LLZO) thin film and a solid-state battery cell are disclosed. The method of making the LLZO thin film includes forming a LLZO sol and/or gel from a lithium precursor, a lanthanum precursor, a zirconium precursor, one or more solvents, water, and an optional dopant, and converting the LLZO sol and/or gel to the LLZO thin film. The method of making the solid-state battery cell includes forming an electrode on an electrically conductive metal-containing substrate, forming a LLZO electrolyte on the electrode using the method of making the LLZO thin film, and depositing a counter-electrode or counter-electrode current collector on the LLZO thin film. A solid-state battery cell having a LLZO electrolyte is also disclosed.

### CROSS-REFERENCE TO RELATED APPLICATIONS

This application claims the benefit of U.S. Provisional Pat. Appl. No. 63/750,738, filed Jan. 28, 2025, pending, incorporated herein by reference in its entirety.

### FIELD OF THE INVENTION

The present invention generally relates to the field of solid-state and/or thin film batteries. More specifically, embodiments of the present invention pertain to methods of making lithium lanthanum zirconium oxide films and lithium-based solid-state batteries containing the same.

### DISCUSSION OF THE BACKGROUND

Lithium-ion batteries are highly efficient storage media for electrical power, and within the last years, considerable research has been performed in this field. A major drawback of current Li-ion battery technology is the use of unstable liquid organic electrolytes. These electrolytes decompose at voltages higher than 4.5 V, are corrosive, sensitive to air and water, and highly flammable.

Solid-state electrolytes greatly improve the reliability and safety of Li-ion batteries. Garnet-type lithium lanthanum zirconium oxide (Li₇La₃Zr₂O₁₂, or LLZO) appears as a candidate solid-state electrolyte material, since it shows the highest reported Li-ion conductivity of all oxide ceramics at room temperature (σ>10⁻⁴ S/cm). Other attractive properties of this material include excellent thermal and chemical stability towards metallic lithium. Compared to the currently practiced liquid Li-ion battery electrolytes, however, LLZO exhibits a significantly lower Li-ion conductivity.

Two crystal structures, tetragonal and cubic, are reported for LLZO. Li-ion conductivity of the cubic system is approximately two orders of magnitude higher than the tetragonal structure. Initially, the cubic structure could only be obtained at a relatively high sintering temperature of around 1000° C. However, for the fabrication of thin-film battery cells, co-sintering processes of the electrolyte and cathode are desirable. Therefore, sintering temperatures as low as possible are desirable to reduce the reaction between LLZ) and an electrode material such as LiCoO₂.

Doping with Al³⁺ or Ga³⁺ is a well-known method to stabilize cubic LLZO at low sintering temperatures, and thus, to achieve a higher Li-ion conductivity. Also, Nb⁵⁺ and Ta⁵⁺ have been used as dopants to substitute for Zr in the crystal lattice. Materials reported in the literature include, e.g., Li_{6.8}La₃(Nb_{0.2}Zr_{1.8})O₁₂ and Li_{6.8}La₃(Ta_{0.2}Zr_{1.8})O₁₂. For these materials, a Li-ion conductivity with values up to 8×10⁻⁴ S/cm at 25° C. has been achieved. However, the previously reported materials were bulk materials, and little information about the preparation and characterization of LLZO thin films has been reported in the literature to date.

Thin films are generally prepared using physical vapor deposition or wet chemical methods. For example, radio frequency magnetron sputtering has been used for depositing LLZO thin films. The conductivity of these thin films was 4×10⁻⁷ S/cm (Kalita et al., Solid State Ionics, 229 [2012], 14-19). LLZO thin films have been deposited on SrTiO₃ and sapphire substrates with pulsed laser deposition. A lithium-ion conductivity of 3.35×10⁻⁷ S/cm was observed (Tan et al., Mater. Res. Soc. Symp. Proc., Vol. 1471 [2012], DOI: 10.1557/opl.2012.1266). In both cases, the LLZO structure was amorphous, limiting the conductivity of the material.

Sol-gel is a well-known method for preparing films of various thicknesses, and it can be attractive for the preparation of materials with a complex composition. Several studies have already been reported on the preparation of LLZO powder and pellets. However, information about the synthesis of sol-gel LLZO thin films is scarce.

Due to the large surface area, in combination with a low volume of material, control of phase composition in coatings is more difficult than with bulk material. Spin-coating an amorphous LLZO sol 12 times achieved a 540 nm-thick coating (Chen et al., J. Mater. Chem. A, 2014, 2, 13277). La₂Zr₂O₇ was obtained instead of cubic Li₇La₃Zr₂O₁₂ after calcination at 800° C. The authors suggest that low sintering temperatures and short sintering times (10 min) are the reasons for the absence of cubic Li₇La₃Zr₂O₁₂. A dip coating process for depositing thin (1 μm thick) LLZO films/coatings on MgO substrates has been reported (Tadanaga et al., Journal of Power Sources, 273 [2015]844-847). In this case, higher heat treatment temperatures (900° C.) and the presence of Li₂CO₃ powder in the sintering crucible yielded a cubic LLZO phase.

This “Discussion of the Background” section is provided for background information only. The statements in this “Discussion of the Background” are not an admission that the subject matter disclosed in this “Discussion of the Background” section constitutes prior art to the present disclosure, and no part of this “Discussion of the Background” section may be used as an admission that any part of this application, including this “Discussion of the Background” section, constitutes prior art to the present disclosure.

### SUMMARY OF THE INVENTION

In order to compensate for the relatively low ion conductivity of bulk LLZO materials, the preparation of thin LLZO electrolyte films could be a solution. The present invention prepares thin LLZO films by sol-gel coating. Thin films have an advantage over bulk materials in that they contribute less overall ohmic resistance in an electronic circuit (such as a battery) than bulk materials (or thick films). When a thin film is used in an electronic circuit, materials with lower conductivity can be candidates for such use. Such thin films can, for example, be used in an “all-ceramic” thin film battery. However, there are multiple issues with using LLZO thin films in solid-state batteries, such as low ionic conductivity at grain boundaries, anisotropic ion transport, high processing temperatures, and limited tunability of the electrolyte composition.

The present invention relates to solid-state and thin film batteries, and more specifically to methods of making lithium lanthanum zirconium oxide (LLZO) films and lithium-based solid-state batteries containing such films. In particular, the present invention concerns sol-gel-derived amorphous LLZO thin films as solid electrolytes for all-solid-state micro-batteries. The invention provides an alternative material (e.g., to lithium phosphorus oxynitride [LiPON] or lithium tungsten oxide [Li₂WO₄]) and an alternative manufacturing method (e.g., to physical vapor deposition [PVD]) for the solid electrolyte layer in all-solid-state micro-batteries.

In one aspect, the present invention relates to a method of making a lithium lanthanum zirconium oxide (LLZO) thin film, comprising forming a LLZO sol and/or gel from a lithium precursor, a lanthanum precursor, a zirconium precursor, one or more solvents, water, and an optional dopant, and converting the LLZO sol and/or gel to the LLZO thin film. The LLZO thin film is generally a fully-oxidized lithium lanthanum zirconium oxide compound, and the dopant (when present) may comprise a source of aluminum (Al), gallium (Ga), indium (In), niobium (Nb), tantalum (Ta), vanadium (V), antimony (Sb), hafnium (Hf) or tin (Sn), and may be present in a molar ratio with respect to zirconium atoms of from 0.01:1 to 1:1 or any molar ratio or range of molar ratios therein (e.g., 0.05:1 to 0.5:1).

In various embodiments, forming the LLZO sol and/or gel comprises preparing a LLZO sol-gel precursor solution, and the method may further comprise coating the LLZO sol-gel precursor solution directly on a substrate prior to converting the LLZO sol and/or gel to the LLZO thin film. Coating the LLZO sol-gel precursor solution may comprise drip casting, spin coating, or dip coating the LLZO sol-gel precursor solution onto the substrate, and may result in the LLZO sol and/or gel being formed on the electrode layer.

In typical embodiments, converting the LLZO sol and/or gel to the LLZO thin film comprises heating, annealing or calcining the LLZO sol and/or gel to form the LLZO thin film. For example, converting the LLZO sol and/or gel to the LLZO thin film may comprise heating the LLZO sol and/or gel at a temperature of 300° C. to 800° C. for a predetermined minimum length of time of 1 minute or more.

Typically, the substrate comprises a metal sheet, foil or film with an electrode layer thereon. In preferred embodiments, the electrode layer comprises a cathode layer (e.g., for a solid-state battery cell). The metal film may be on a mechanical substrate, such as a polymeric or ceramic sheet or disc. When the electrode layer is an electrode precursor layer (e.g., a cathode precursor layer prior to drying and heating, annealing or calcining), heating, annealing or calcining the LLZO sol and/or gel may also convert the electrode precursor layer to the electrode layer.

In preferred embodiments, the LLZO thin film is amorphous. For example, the LLZO film may be completely or substantially completely amorphous, and may contain <10 % by area or volume of tetragonal or cubic LLZO.

In typical embodiments, the LLZO film has a thickness of 20 nm-3 μm, or any thickness or range of thicknesses therein (e.g., 300-100 nm). In some cases, part or all of the method of forming the LLZO thin film may be repeated until the LLZO film has a predetermined thickness, or a thickness within a target range.

In various embodiments, forming the LLZO sol-gel comprises mixing the lithium precursor, the lanthanum precursor, the zirconium precursor, the solvent(s), and the optional dopant in a mixing vessel in one or more steps to form a homogeneous mixture of the lithium precursor, the lanthanum precursor, the zirconium precursor, the solvent(s), and the dopant (when present), and hydrolyzing the homogeneous mixture. The lithium precursor, the lanthanum precursor, the zirconium precursor, the solvent(s), and the optional dopant may be mixed at a temperature in the range 0-100° C., and the mixture may be independently hydrolyzed at a temperature in the range 0-100° C.

More specifically, hydrolyzing the homogeneous mixture may comprise adding a molar excess of water to the homogeneous mixture, and mixing the homogeneous mixture and the water until hydrolysis is substantially complete. The water may comprise deionized and/or distilled water. Mixing may comprise stirring, homogenizing or shaking at a temperature in a range of 0-100° C. for a length of time of from 1 hour to 48 hours. In some examples, the homogeneous mixture can be hydrolyzed in the mixing vessel. In general, the number of moles of water added to the homogeneous mixture is greater than a combined number of moles of lithium atoms divided by 2, moles of lanthanum atoms times 1.5, moles of zirconium atoms times 2, and moles of dopant atoms (when present) times 1.5, 2 or 2.5, depending on the oxidation state of the dopant. Typically, the amount of water is a multiple of at least 2 times the combined number of moles of lithium atoms, lanthanum atoms, zirconium atoms, and dopant atoms (adjusted for oxidation states, as set forth above). The maximum amount of water may be 1000 molar excesses or less.

In some embodiments, hydrolyzing the homogeneous mixture further comprises adding 0.01-15 moles of a catalyst per mole of lanthanum and/or zirconium atoms in the homogeneous mixture. The catalyst may be selected from mineral acids, volatile carboxylic acids, and inorganic hydroxides. In some examples, the water is provided in part or in whole with the catalyst.

In further embodiments, converting the LLZO sol and/or gel to the LLZO thin film may (further) comprise drying the LLZO sol and/or gel to remove the solvent(s), any excess water, and any additional volatile components or materials in the LLZO sol and/or gel prior to heating, annealing or calcining the LLZO sol and/or gel. For example, the LLZO thin film may be dried at a temperature of 50-150° C. for a length of time of from 5 minutes to 2 hours.

In various embodiments, the lithium precursor may comprise a lithium halide, a lithium pseudohalide, a lithium alkoxide, a lithium aralkoxide, a lithium alkylcarboxylate, a lithium aralkylcarboxylate, a lithium alkylthiolate, or a lithium aralkylthiolate that is soluble in the solvent(s); the lanthanum precursor may comprise a lanthanum halide, a lanthanum pseudohalide, a lanthanum alkoxide, a lanthanum alkylcarboxylate or a lanthanum diketonate compound that is soluble in the solvent(s); the zirconium precursor may comprise a zirconium halide, a zirconium pseudohalide, a zirconium alkoxide, a zirconium alkylcarboxylate or a zirconium diketonate compound that is soluble in the solvent(s); and/or the solvent(s) may comprise an organic solvent or organic solvent mixture that uniformly and/or homogeneously dissolves the lithium precursor, the lanthanum precursor, and the zirconium precursor. The lithium halide may be selected from lithium fluoride, lithium chloride, lithium bromide, and lithium iodide; the lithium pseudohalide may be selected from lithium nitrate, lithium sulfate, lithium methylsulfonate, lithium trifluoromethylsulfonate, and lithium phosphates; the lithium alkoxide may be selected from lithium salts of straight-chain or branched C₁-C₆ alkoxides; the lithium aralkoxide may be lithium benzyloxide; the lithium alkylcarboxylate may be selected from lithium salts of straight-chain or branched C₁-C₆ carboxylic acids; the lithium aralkylcarboxylate may be lithium benzoate; the lithium alkylthiolate may be selected from lithium salts of straight-chain or branched C₁-C₄ alkylthiols; and the lithium aralkylthiolate may be lithium benzylthiolate. The lanthanum halide may be lanthanum chloride; the lanthanum pseudohalide may be selected from lanthanum nitrate and lanthanum sulfate; the lanthanum alkoxide may be selected from lanthanum salts of straight-chain or branched C₁-C₄ alkoxides; the lanthanum alkylcarboxylate may be selected from lanthanum salts of straight-chain or branched C₁-C₄ carboxylic acids; and the lanthanum diketonate may be selected from lanthanum salts and/or complexes of straight-chain or branched C₅-C₁₀ β-diketones, C₄-C₆ β-ketocarboxylic acid esters, and C₃-C₅ β-dicarboxylic acid esters. The zirconium halide may be selected from zirconium fluoride and zirconium chloride; the zirconium pseudohalide may be selected from zirconium nitrate and zirconium sulfate; the zirconium alkoxide may be selected from zirconium salts of straight-chain or branched C₁-C₄ alkoxides; the zirconium alkylcarboxylate may be selected from zirconium salts of straight-chain or branched C₁-C₄ carboxylic acids; and the zirconium diketonate may be selected from zirconium salts and/or complexes of straight-chain or branched C₅-C₁₀ β-diketones, C₄-C₆ β-ketocarboxylic acid esters, and C₃-C₅ β-dicarboxylic acid esters. The solvent(s) may comprise one or more acyclic or cyclic C₄-C₆ ethers, acyclic or cyclic C₄-C₈ polyethers, C₃-C₆ ether alcohols, straight-chain or branched C₁-C₁₀ alcohols, straight-chain or branched C₂-C₄ polyalcohols, acyclic or cyclic, straight-chain or branched C₅-C₁₀ alkanes, straight-chain or branched C₁-C₄ haloalkanes, arenes, haloarenes, dimethyl formamide and dimethyl sulfoxide. In further embodiments, the solvent or solvent mixture has a viscosity of at least 2 cP.

In embodiments containing a dopant, the LLZO thin film includes one or more Group 5, Group 13, or Group 15 metal or metalloid dopants that have a stable +3 or +5 oxidation state. In particular embodiments, the dopant may comprises a halide, pseudohalide, alkoxide, alkylcarboxylate or diketonate compound of aluminum (Al), gallium (Ga), indium (In), niobium (Nb), tantalum (Ta), vanadium (V), antimony (Sb), cerium (Ce), neodymium (Nd), ytterbium (Yb), hafnium (Hf) or tin (Sn) that is soluble in the one or more solvents.

In various embodiments, the method first prepares a doped or undoped LLZO sol-gel precursor solution, and then coats the LLZO sol-gel precursor solution directly or indirectly on an electrode layer (e.g., a LiCoO₂ cathode) using a conventional coating technique, such as drip casting, spin coating, dip coating, etc., resulting in an LLZO sol and/or gel (e.g., a “green coating”) on the electrode. The LLZO sol and/or gel is converted to the LLZO thin film by heating at a predetermined temperature for a predetermined minimum length of time (e.g., by calcination). After heating, the LLZO sol/gel is converted into a solid LLZO electrolyte thin film with high lithium-ion conductivity. The predetermined temperature may be in the range of from 300° C. to 800° C. (or any temperature or range of temperatures therein, such as 550-650° C.), and the minimum length of time may be 1 minute, 2 minutes, 3 minutes, 5 minutes, or more (e.g., in the range of 5-60 minutes, or any length of time or range of lengths of times from 1 to 60 minutes or longer).

Another aspect of the present invention relates to a method of making a lithium-based solid-state battery or battery cell, comprising forming an electrode (e.g., a lithium metal oxide cathode layer) on an electrically conductive metal-containing substrate, coating the electrode with a LLZO sol and/or gel, converting the LLZO sol and/or gel to a LLZO thin film (e.g., a solid-state or solid-phase LLZO electrolyte), and depositing a counter-electrode or counter-electrode current collector (e.g., a conductive elemental metal or metal alloy anode film) on the LLZO thin film and/or electrolyte. The metal-containing substrate may function as a cathode current collector in the solid-state battery or battery cell. Certain steps in the method of making a lithium-based solid-state battery or battery cell (e.g., forming or depositing the cathode layer, forming an anode and/or the anode current collector, forming electrical contacts to the cathode current collector and anode/anode current collector, forming one or more interface layers between the electrolyte and one or both electrodes, and encapsulating and/or packaging the battery or battery cell) are disclosed in U.S. Pat. Nos. 11,735,791 and 11,916,192, U.S. Pat. Appl. Publ. Nos. 2024/0128498, 2023/0378606, 2023/0420731 and 2024/0113341, and in U.S. patent application Ser. Nos. 18/473,218, 18/925,892, 18/925,267, 18/640,416 and 18/946,887 (Attorney Docket Nos. IDR2020-01, IDR2020-03, IDR2022-01, IDR2022-02, IDR2022-03, IDR2022-04, IDR2022-05, IDR2022-07, IDR2022-08, IDR2022-09 and IDR2022-10), the relevant portions of which are incorporated herein by reference. In some embodiments, the metal substrate may comprise a metal foil (e.g., stainless steel, titanium, copper, etc.), and in other or further embodiments, the metal substrate or foil may further comprise a diffusion barrier (e.g., a conductive and/or amorphous barrier layer) thereon.

In the method of making a solid-state battery cell using the LLZO thin film as an electrolyte, the counter-electrode or counter-electrode current collector may comprise an anode current collector (ACC), which typically comprises an electrically conductive metal layer. Thus, coating the LLZO thin film with the electrically conductive metal layer results in fabrication of a full anode-less lithium solid-state battery cell. Compared to LiPON prepared by vacuum-based PVD, LLZO thin films prepared by the present sol-gel method show significant advantages in terms of cost reduction and defect mitigation.

As for the method of making a LLZO thin film, in the method of making a solid-state battery cell, the substrate may comprise a metal foil or film having a thickness of 10-100 μm. The metal foil may comprise or consist essentially of stainless steel, aluminum, copper, nickel, inconel, brass, molybdenum or titanium, the elemental metals of which may be alloyed with up to 10% of one or more other elements. The substrate may also further comprise a barrier having a thickness effective to prevent migration of atoms or ions from the metal foil or film into overlying layers, which in some instances may comprise a plurality of layers of alternating materials, having a total thickness of 0.5-3 μm. The barrier may comprise one or more layers of one or more materials selected from electrically conductive materials, such as metal nitrides and refractory metal nitrides, amorphous refractory metal alloys (e.g., TiW alloy), and glasses and ceramics. The barrier may be blanket-deposited onto the substrate by chemical or physical vapor deposition, or solution-phase coating with a precursor material, followed by annealing (e.g., to form the glass, ceramic or metal nitride).

In various embodiments, the electrode comprises a lithium metal oxide cathode layer, as described herein. In some embodiments, forming the lithium metal oxide cathode layer may comprise depositing a cathode precursor layer on the substrate. The cathode precursor layer generally comprises a lithium metal oxide or precursor thereof, such as a lithium-transition metal oxide, a fully-oxidized lithium-transition metal compound, or a nickel-manganese-cobalt oxide. In some cases, the cathode precursor layer may be blanket-deposited by laser deposition (e.g., pulsed laser deposition or PLD), sputtering, or chemical vapor deposition (CVD). Alternatively, the cathode precursor layer may be deposited by coating, optionally from a sol-gel of the cathode precursor, screen printing, inkjet printing, spray coating, or extrusion coating using an ink comprising one or more sol-gel precursors of the cathode. In embodiments including depositing the cathode precursor layer, converting the LLZO sol and/or gel to the LLZO thin film may simultaneously convert the cathode precursor layer to a cathode and the LLZO sol and/or gel to the LLZO electrolyte.

Similarly to the method of making a LLZO thin film, in the method of making a solid-state battery cell, converting the LLZO sol and/or gel to the LLZO thin film comprises heating, annealing or calcining the LLZO sol and/or gel (and, in some embodiments, the cathode precursor layer) in an oven or furnace. The LLZO sol and/or gel (and, in some embodiments, the cathode precursor layer) may be heated, annealed or calcined at a temperature of 500-800° C. for 1-60 minutes, although the invention is not limited to these ranges. Converting the LLZO sol and/or gel to the LLZO thin film may further comprise flowing an oxygen-containing gas (e.g., clean dry air [CDA]) through the oven or furnace.

In embodiments in which the electrode comprises a cathode layer, the counter-electrode or counter-electrode current collector may comprise an anode current collector (ACC). The ACC may comprise a conductive elemental metal or metal alloy anode film. The conductive elemental metal or metal alloy may comprise nickel, zinc, copper, and metal alloys thereof. In various embodiments, depositing the ACC comprises screen printing, inkjet printing, spray coating, or blanket deposition and patterning a material forming the ACC. The ACC may have a thickness of 0.1-5 μm.

In some embodiments, the ACC has borders offset from borders of the solid-state battery cell sufficient to electrically isolate the ACC from the cathode and substrate. For example, the ACC may have area dimensions (i.e., a length and a width) that are 50-95% of the corresponding area dimensions of the solid-state battery cell.

In other or further embodiments, the method of making a solid-state battery cell may further comprise forming one or more interlayers on the cathode and/or the LLZO thin film. Forming the one or more interlayers may comprise depositing an amorphous interlayer on the LLZO thin film prior to depositing the ACC and/or depositing a metal oxide interlayer on the cathode prior to coating the cathode with the LLZO sol and/or gel. The amorphous interlayer may be or comprise elemental silicon, and the metal oxide interlayer may comprise Nb₂O₅, Al₂O₃, Li₄Ti₅O₁₂ or LiNbO₃.

Yet another aspect of the present invention concerns a solid-state battery cell, comprising an electrically conductive metal-containing substrate, an electrode on the substrate, a doped or undoped lithium lanthanum zirconium oxide (LLZO) electrolyte on the electrode, and a counter-electrode or counter-electrode current collector on the LLZO electrolyte. The LLZO electrolyte is amorphous, contains <10 % by area or volume of tetragonal or cubic LLZO, and has a thickness of 20 nm-3 μm, or any thickness or range of thicknesses therein (e.g., 300-1000 nm).

As for the present methods, the LLZO electrolyte is advantageously amorphous, as described herein. Furthermore, in embodiments in which the LLZO electrolyte is undoped, the LLZO may have a formula Li₇La₃Zr₂O₁₂. In embodiments in which the LLZO electrolyte is doped, the LLZO electrolyte may contain a dopant selected from aluminum (Al), gallium (Ga), indium (In), niobium (Nb), tantalum (Ta), vanadium (V), antimony (Sb), hafnium (Hf), tin (Sn), cerium (Ce), neodymium (Nd) and ytterbium (Yb), which may be is present in a molar ratio with respect to zirconium atoms of from 0.01:1 to 1:1.

As for the present methods, the substrate in the present solid-state battery cell may comprise a metal foil, sheet or film. The metal foil or film may have a thickness of 10-100 μm. The metal foil may comprise or consist essentially of stainless steel, aluminum, copper, nickel, inconel, brass, molybdenum or titanium, the elemental metals of which may be alloyed with up to 10% of one or more other elements. The metal-containing substrate may further comprise a barrier having a thickness effective to prevent migration of atoms or ions from the metal foil, sheet or film into overlying layers. The barrier may comprise one or more layers of one or more materials selected from electrically conductive materials, such as metal nitrides and refractory metal nitrides, amorphous refractory metal alloys (e.g., TiW alloy), and glasses and ceramics, and may have a total thickness of 0.5-3 μm.

As for the present methods, the electrode in the present solid-state battery cell may comprise a lithium metal oxide cathode layer, and the counter-electrode or counter-electrode current collector comprises an anode current collector (ACC). The lithium metal oxide cathode layer may comprise a lithium-transition metal oxide, a fully-oxidized lithium-transition metal compound, or a nickel-manganese-cobalt oxide, as described herein. The ACC may comprise a conductive elemental metal or metal alloy anode film. The conductive elemental metal or metal alloy may comprise nickel, zinc, copper, and metal alloys thereof, and may have a thickness of 0.1-5 μm.

As for the present methods, the ACC may have borders offset from borders of the solid-state battery cell sufficient to electrically isolate the ACC from the cathode and substrate. For example, the ACC may have area dimensions that are 50-95% of the corresponding area dimensions of the solid-state battery cell.

In various embodiments, the solid-state battery cell may further comprise one or more interlayers on the cathode and/or the LLZO electrolyte. For example, one such interlayer may comprise an amorphous interlayer between the LLZO electrolyte and the ACC. Another such interlayer may comprise a metal oxide interlayer between the cathode and the LLZO electrolyte. The amorphous interlayer may be or comprise elemental silicon, and the metal oxide interlayer may comprise Nb₂O₅, Al₂O₃, Li₄Ti₅O₁₂ or LiNbO₃.

Other capabilities and advantages of the present invention will become readily apparent from the detailed description of various embodiments below.

### BRIEF DESCRIPTION OF THE DRAWINGS

FIG. 1 shows an exemplary process for making a lithium lanthanum zirconium oxide (LLZO) film in accordance with the present invention.

FIG. 2 is an image of an exemplary tantalum-doped lithium lanthanum zirconium oxide (LLZTO) film on a silicon substrate, in accordance with an embodiment of the present invention.

FIGS. 3A-B are scanning electron microscope (SEM) images of LLZTO thin films obtained from a LLZTO sol containing 1 wt % polyvinylpyrrolidone (PVP) (FIG. 3A) and without the PVP (FIG. 3B).

FIGS. 4A-D depict intermediates in an exemplary method of making a solid-state battery cell including an LLZO film, in accordance with embodiments of the present invention.

FIGS. 5-6 are graphs showing the cycling performance of a half-cell including a LiCoO₂ thin film cathode covered with an LLZTO sol-gel layer of 250 nm thickness, in accordance with the present invention.

FIG. 7 is a graph showing cycling behavior of a prototype cell including a 2 μm-thick LLZTO electrolyte layer made by the present sol-gel method, charged and discharged at a constant current of 50 μA between 3.95 V and 3 V, in accordance with the present invention.

### DETAILED DESCRIPTION

Reference will now be made in detail to one or more embodiments of the invention, examples of which are illustrated in the accompanying drawings. While the invention will be described in conjunction with the following embodiments, it will be understood that the descriptions are not intended to limit the invention to these embodiments. On the contrary, the invention is intended to cover alternatives, modifications and equivalents that may be included within the spirit and scope of the invention. Furthermore, in the following detailed description, numerous specific details are set forth in order to provide a thorough understanding of the present invention. However, it will be readily apparent to one skilled in the art that the present invention may be practiced without these specific details. In other instances, well-known methods, procedures and components have not been described in detail so as not to unnecessarily obscure aspects of the present invention. Furthermore, it should be understood that the possible permutations and combinations described herein are not meant to limit the invention. Specifically, variations that are not inconsistent may be mixed and matched as desired.

The technical proposal(s) of embodiments of the present invention will be fully and clearly described in conjunction with the drawings in the following embodiments. It will be understood that the descriptions are not intended to limit the invention to these embodiments. Based on the described embodiments of the present invention, other embodiments can be obtained by one skilled in the art without creative contribution and are in the scope of legal protection given to the present invention.

Furthermore, all characteristics, measures or processes disclosed in this document, except characteristics and/or processes that are mutually exclusive, can be combined in any manner and in any combination possible. Any characteristic disclosed in the present specification, claims, Abstract and Figures can be replaced by other equivalent characteristics or characteristics with similar objectives, purposes and/or functions, unless specified otherwise.

For the sake of convenience and simplicity, “part,” “portion,” and “region” may be used interchangeably herein, but are generally given their art-recognized meanings. Wherever one such term is used, it also encompasses the other terms. Also, unless indicated otherwise from the context of its use herein, the terms “known,” “fixed,” “given,” “certain” and “predetermined” generally refer to a value, quantity, parameter, constraint, condition, state, process, procedure, method, practice, or combination thereof that is, in theory, variable, but is typically set in advance and not varied thereafter when in use.

The term “length” generally refers to the largest dimension of a given 3-dimensional structure or feature. The term “width” generally refers to the second largest dimension of a given 3-dimensional structure or feature. The term “thickness” generally refers to a smallest dimension of a given 3-dimensional structure or feature. The length and the width, or the width and the thickness, may be the same in some cases. A “major surface” refers to a surface defined by the two largest dimensions of a given structure or feature, which in the case of a structure or feature having a circular surface, may be defined by the radius of the circle.

The terms “lower” and “upper” are used herein as convenient labels for the same or similar structures having a relative position to the other(s) as shown in the drawings, but which can change their relative position(s) depending on the orientation of the apparatus or other structure in the drawing(s). Similarly, the terms “downstream” and “upstream” are convenient labels for relative positions of two or more components of an apparatus or system with respect to the flow of one or more gas(es) or fluid(s) within the apparatus or system. Also, for convenience and simplicity, the terms “connected to,” “coupled with,” “coupled to,” “joined to,” “attached to,” “fixed to,” “affixed to,” “in communication with,” and grammatical variations thereof may be used interchangeably, and refer to both direct and indirect connections, couplings, joints, attachments and communications (unless the context of its use unambiguously indicates otherwise), but these terms are also generally given their art-recognized meanings.

Herein, the term “lithium lanthanum zirconium oxide” or “LLZO” refers to a fully-oxidized lithium lanthanum zirconium oxide compound, which may include one or more metal or metalloid dopants (e.g., a Group 5, Group 13, or Group 15 metal or metalloid that can have a stable +3 or +5 oxidation state) that have or provide characteristics and/or properties suitable and/or beneficial for an electrolyte in a solid-state battery or battery cell.

### Exemplary Methods of Making a Lithium Lanthanum Zirconium Oxide Film

Despite the potential promise of LLZO films as electrolyte materials, there are issues with LLZO films in solid-state batteries, such as low ionic conductivity at grain boundaries, anisotropic ion transport, high processing temperatures, and limited tunability of the LLZO composition. Amorphous materials could be an alternative for resolving such issues. For example, amorphous Li—La—Zr—O thin films, based on the primitive stoichiometric ratio of LLZO (i.e., Li₇La₃Zr₂O₁₂), have certain advantageous properties of amorphous materials, such as the lack of grain boundary, intimate contact with electrode materials, and low processing temperatures.

High homogeneity with facile molecular-level mixing and relatively low energy consumption is beneficial for efficient determination of compositions, fabrication processing parameters, and optimized properties of amorphous materials. Sol-gel processing includes such advantages, and is thus favorable for determining such compositions, parameters, and properties, in addition to fabricating amorphous LLZO films.

In accordance with one aspect of the present invention, the method of making a lithium lanthanum zirconium oxide (LLZO) film generally comprising forming a LLZO sol and/or gel (herein, a “LLZO sol-gel”) from a lithium precursor, a lanthanum precursor, a zirconium precursor, one or more solvents, water, and an optional dopant, and converting the LLZO sol-gel to the LLZO film. In most embodiments, the LLZO sol-gel is formed in two phases: a mixing phase, and a hydrolysis phase. Both phases can be conducted at room temperature, minimizing the energy consumption in making the sol-gel. However, other temperatures (e.g., in the range 0-100° C.) are suitable, and in some cases, may be desirable to control (i) the rate of mixing and/or reaction and/or (ii) the homogeneity of the mixture.

The mixing phase combines at least the lithium precursor, the lanthanum precursor, the solvent(s), and the optional dopant in a mixing vessel (which may also serve as the reaction vessel for the hydrolysis phase). The zirconium precursor may be added at the same time as the lithium precursor, the lanthanum precursor, the solvent(s), and the optional dopant, or after the lithium precursor, the lanthanum precursor, the solvent(s), and the optional dopant are first mixed to homogeneity. The precursors, solvent(s) and optional dopant may be mixed conventionally, for example by stirring with a homogenizer or a mechanical or magnetic stirrer, shaking with a cone or drum mixer, etc.

The mixing phase is generally conducted at ambient (room) temperature (e.g., 15-30° C., or any temperature or range of temperatures therein, such as 18-25° C.), although a higher temperature, such as 35-100° C. any temperature or range of temperatures therein (such as 35-50° C.) may be suitable in some cases. The mixing phase is generally conducted until the mixture of the lithium precursor, the lanthanum precursor, the zirconium precursor, the solvent(s), and the optional dopant are homogeneous. However, as homogeneity of such a mixture may be difficult to discern in some instances, the mixing phase may generally be conducted for a length of time of 10 minutes to 6 hours. The length of time may be less when the mixture is heated to a temperature above room temperature, or the scale is relatively small (e.g., <1 kg of components total in the mixture). The length of time may be greater when the mixture is prepared on a large scale (e.g., 3-5 kilograms or greater, for manufacturing high volumes of battery cells and/or large-area battery cells).

In some embodiments, the mixing phase comprises two steps: first, the lithium precursor, the lanthanum precursor, the solvent(s), and the optional dopant are mixed to homogeneity, then the zirconium precursor is added to the homogeneous lithium precursor-lanthanum precursor-solvent (and optional dopant) mixture and mixed until homogeneous. In such a two-step mixing phase, the first step (mixing the lithium precursor, the lanthanum precursor, the solvent(s), and the optional dopant) may be conducted for 5-120 minutes, or any length of time or range of lengths of time therein (e.g., 15-20 minutes), and the second step (adding the zirconium precursor to the homogeneous lithium precursor-lanthanum precursor-solvent[-dopant] mixture and then mixing) may be conducted for 15-360 minutes, or any length of time or range of lengths of time therein (e.g., 60-240 minutes). As described above, the mixtures in each of the two mixing steps can be heated to a temperature above ambient temperature (e.g., 35-100° C.) or cooled to a temperature below ambient temperature (e.g., 0-15° C.). Furthermore, the lengths of time for the mixing steps may be less when the mixture is heated to a temperature above room temperature or the scale is relatively small, and may be greater when the mixture is prepared on a relatively large scale.

The dopant may comprise a source of aluminum (Al), gallium (Ga), indium (In), niobium (Nb), tantalum (Ta), vanadium (V), antimony (Sb) or other metal or metalloid capable of having a stable +3 or +5 oxidation state. Thus, other lanthanides, such as cerium (Ce), neodymium (Nd), ytterbium (Yb), etc., may be useful as dopants in the present LLZO films. Alternatively, a metal or metalloid dopant with a stable +4 oxidation state (e.g., hafnium [Hf] or tin [Sn]) may also be suitable for the present amorphous LLZO thin film. The dopant may be present in a molar ratio with respect to zirconium atoms of from 0.01:1 to 1:1 or any molar ratio or range of molar ratios therein (e.g., 0.05:1 to 0.5:1).

The lithium precursor may comprise any lithium halide, pseudohalide, alkoxide, aralkoxide, alkylcarboxylate, aralkylcarboxylate, alkylthiolate, or aralkylthiolate compound that is soluble in the solvent(s). Lithium halides may include lithium fluoride, lithium chloride, lithium bromide, and lithium iodide; lithium pseudohalides may include lithium nitrate, lithium sulfate, lithium methylsulfonate, lithium trifluoromethylsulfonate, and lithium phosphate (mono-, di-or tribasic lithium phosphate); lithium alkoxides may include lithium salts of straight-chain or branched C₁-C₆ alkoxides, such as lithium methoxide, lithium ethoxide, lithium n-propoxide, lithium isopropoxide, lithium n-butoxide, lithium t-butoxide, lithium n-hexoxide and lithium t-hexoxide (e.g., lithium 1,1-dimethylbutoxide); lithium aralkoxides may include lithium benzyloxide; lithium alkylcarboxylates may include lithium salts of straight-chain or branched C₁-C₆ carboxylic acids, such as lithium formate, lithium acetate, lithium propanoate, lithium butyrate and lithium hexanoate; lithium aralkylcarboxylates may include lithium benzoate; lithium alkylthiolates may include lithium salts of straight-chain or branched C₁-C₄ alkylthiols, such as lithium methylthiolate, lithium ethylthiolate, lithium n-propylthiolate and lithium t-butylthiolate; and lithium aralkylthiolates may include lithium benzylthiolate.

The lanthanum precursor may comprise any lanthanum halide, pseudohalide, alkoxide, alkylcarboxylate or diketonate compound that is soluble in the solvent(s). Lanthanum halides may include lanthanum chloride (anhydrous or as a hydrate [e.g., a heptahydrate]); lanthanum pseudohalides may include lanthanum nitrate (anhydrous or as a hydrate [e.g., a hexahydrate]) and lanthanum sulfate; lanthanum alkoxides may include lanthanum salts of straight-chain or branched C₁-C₄ alkoxides, such as lanthanum methoxide, lanthanum ethoxide, lanthanum n-propoxide, lanthanum isopropoxide, lanthanum n-butoxide, and lanthanum t-butoxide; lanthanum alkylcarboxylates may include lanthanum salts of straight-chain or branched C₁-C₄ carboxylic acids, such as lanthanum formate, lanthanum acetate, lanthanum propanoate and lanthanum t-butyrate; and lanthanum diketonates may include lanthanum salts and/or complexes of straight-chain or branched C₅-C₁₀ β-diketones, C₄-C₆ β-ketocarboxylic acid esters, and C₃-C₅ β-dicarboxylic acid esters, such as tris(2,4-pentanedionato)lanthanum, tris(methyl 3-oxobutanoate)lanthanum, and tris(dimethyl malonate)lanthanum.

The solvent can be essentially any organic solvent or solvent mixture that uniformly and/or homogeneously dissolves the lithium precursor, the lanthanum precursor, the zirconium precursor, and any dopant precursor. Preferably, the solvent(s). For example, the solvent may include one or more acyclic or cyclic C₄-C₆ ethers, such as diethyl ether, methyl t-butyl ether and tetrahydrofuran; acyclic or cyclic C₄-C₈ polyethers, such as dimethoxy ethane, diethoxy ethane, di-2-methoxyethyl ether and dioxane; C₃-C₆ ether alcohols, such as 2-methoxyethanol, 2-ethoxyethanol, 3-methoxypropanol, 3-ethoxypropanol and 2-(2-methoxy-ethoxy)ethanol; straight-chain or branched C₁-C₁₀ alcohols, such as methanol, ethanol, n-propanol, isopropanol, n-butanol, isobutanol, t-butanol, n-hexanol, octanol and decanol; straight-chain or branched C₂-C₄ polyalcohols, such as ethylene glycol, propylene glycol and glycerin; acyclic or cyclic, straight-chain or branched C₅-C₁₀ alkanes, such as pentane(s), hexane(s), octane(s), decane(s), cyclohexane and cyclooctane; straight-chain or branched C₁-C₄ haloalkanes, such as dichloromethane, 1,1-dichloroethane, 1,2-dichloroethane, 1,1,1-trichloroethane, 1,1,2-trichloroethane, 2-chloropropane, 1,2-dichloropropane and 1,2,3-trichloropropane; arenes and haloarenes, such as benzene, chlorobenzene, dichlorobenzene, fluorobenzene and perfluorobenzene; and other polar organic solvents, such as dimethyl formamide and dimethyl sulfoxide. In some embodiments, the solvent or solvent mixture has a viscosity suitable for coating a substrate in a sol-gel process (e.g., of at least 2 cP).

The zirconium precursor may comprise any zirconium halide, pseudohalide, alkoxide, alkylcarboxylate or diketonate compound that is soluble in the solvent(s). Zirconium halides may include zirconium fluoride and zirconium chloride; zirconium pseudohalides may include zirconium nitrate and zirconium sulfate; zirconium alkoxides may include zirconium salts of straight-chain or branched C₁-C₄ alkoxides, such as zirconium methoxide, zirconium ethoxide, zirconium n-propoxide, zirconium isopropoxide, zirconium n-butoxide, and zirconium t-butoxide; zirconium alkylcarboxylates may include zirconium salts of straight-chain or branched C₁-C₄ carboxylic acids, such as zirconium formate, zirconium acetate, zirconium propanoate and zirconium t-butyrate; and zirconium diketonates may include zirconium salts and/or complexes of straight-chain or branched C₅-C₁₀ β-diketones, C₄-C₆ β-ketocarboxylic acid esters, and C₃-C₅ β-dicarboxylic acid esters, such as tris(2,4-pentanedionato)zirconium, tris(methyl 3-oxobutanoate)zirconium, and tris(dimethyl malonate)zirconium. For sol-gel processing, zirconium alkoxides are particularly useful. Zirconium alkoxides are often commercially available as solutions (e.g., 50-90% by weight) in the corresponding alcohol. For example, zirconium n-propoxide is commercially available as a 70 wt % solution in n-propanol.

The dopant source may comprise any halide, pseudohalide, alkoxide, alkylcarboxylate or diketonate compound of a dopant metal or metalloid (e.g., aluminum [Al], gallium [Ga], indium [In], niobium [Nb], tantalum [Ta], vanadium [V], antimony [Sb], cerium [Ce], neodymium [Nd], ytterbium [Yb], hafnium [Hf] or tin [Sn]) that is soluble in the solvent(s). Halides may include fluorides, chlorides and iodides of gallium, indium, niobium, tantalum, vanadium, antimony, cerium, neodymium, ytterbium, hafnium and tin; pseudohalides may include nitrates, sulfates, methylsulfonates and trifluoromethylsulfonates of aluminum, gallium, indium, niobium, tantalum, vanadium, antimony, cerium, neodymium, ytterbium and hafnium; alkoxides may include straight-chain or branched C₁-C₄ alkoxide salts, such as methoxides, ethoxides, n-propoxides, isopropoxides, n-butoxides and t-butoxides of aluminum, niobium, tantalum, vanadium, gallium, indium, antimony, cerium, neodymium, ytterbium, hafnium and tin; alkylcarboxylates may include zirconium salts of straight-chain or branched C₁-C₄ carboxylic acids, such as formates and acetates of niobium, tantalum, vanadium, cerium, neodymium, ytterbium, hafnium and tin; and diketonates may include salts and/or complexes of straight-chain or branched C₅-C₇ β-diketones, C₄-C₆ β-ketocarboxylic acid esters, and C₃-C₅ β-dicarboxylic acid esters, such as 2,4-pentanedionato-, methyl 3-oxobutanoate, and dimethyl malonate salts and complexes of niobium, tantalum, vanadium, cerium, neodymium, ytterbium and hafnium. For sol-gel processing, alkoxides (e.g., tantalum ethoxide, gallium isopropoxide, niobium ethoxide, vanadium oxytripropoxide, etc.) are particularly useful.

The hydrolysis phase (e.g., to make the LLZTO precursor sol/gel) typically comprises adding water (typically in a molar excess) to the homogeneous LLZO precursor mixture and mixing until the hydrolysis is substantially complete. Mixing may comprise stirring, homogenizing or shaking as disclosed herein, at a temperature in a range of 0-100° C. (or any other temperature or temperature range therein; e.g., ambient or room temperature), for a length of time of from 1 hour to 48 hours or more. Typically, the hydrolysis phase is conducted in the same vessel as the mixing process(es), but the invention is not limited to this condition. In some embodiments, the hydrolysis phase may be facilitated by adding a small amount of a catalyst (e.g., 0.01-15 moles per mole of lanthanum, zirconium and optional dopant in the homogeneous LLZO precursor mixture). Suitable catalysts include mineral acids, such as HCl (anhydrous or aqueous), HF (typically as a dilute aqueous solution), dilute aqueous HNO₃, dilute aqueous H₃PO₄, and dilute aqueous H₂SO₄, relatively volatile carboxylic acids such as formic acid and acetic acid, and inorganic hydroxides such as lithium hydroxide, ammonium hydroxide (e.g., as a concentrated or dilute aqueous solution), lanthanum hydroxide, zirconium hydroxide and stable hydroxides of the dopant. As for the mixing steps, the length of time for the hydrolysis phase may be less when the mixture is heated to a temperature above room temperature, the scale is relatively small, or a catalyst is used, and may be greater when the conducted on a relatively large scale, at a relatively low temperature, and/or in the absence of a catalyst.

The water for the hydrolysis may comprise deionized and/or distilled water. The water may also be provided in part or in whole with the catalyst (e.g., a dilute solution of mineral acid or inorganic hydroxide). Generally, the water is added in a molar excess. In other words, the number of moles of water added is greater than the combined number of moles of lithium atoms (which may be divided by 2), moles of lanthanum times 1.5, moles of zirconium times 2, and moles of dopant times 1.5, 2 or 2.5, depending on the formal oxidation state of the dopant. Typically, the amount of water is at least a multiple of the molar excess, where the multiple is a number >2 (e.g., 3, 5, 10 or any other number >2). The maximum amount of water may be determined by the desired properties for the resulting sol-gel (e.g., solubility, homogeneity, viscosity, etc.), and may be on the order of 20, 50, 100 or 1000 molar excesses.

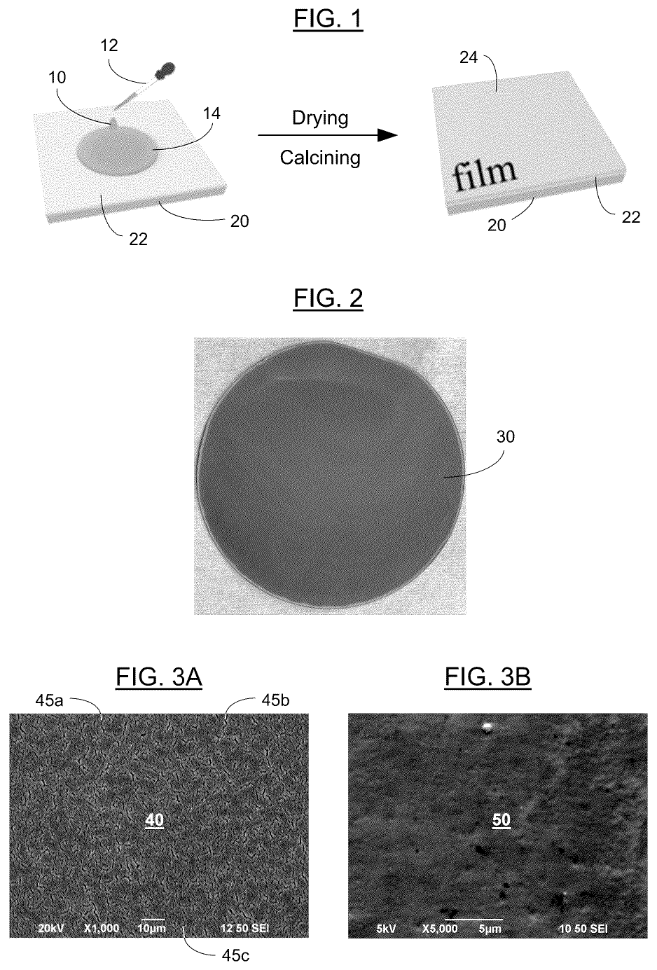

FIG. 1 is a schematic diagram demonstrating an exemplary procedure for preparing LLZO thin films by the sol-gel method. The hydrolyzed LLZO precursor mixture (or LLZO sol-gel) 10 is applied to an electrode (or electrode precursor) layer 22 on a substrate 20 by drip casting, using a dropper 12 or syringe (not shown). The electrode (precursor) layer 22 may be a cathode layer for a solid-state battery cell, and the substrate may comprise a metal sheet, foil or film. The metal film may be on a mechanical substrate, such as a polymeric or ceramic sheet or disc (e.g., a monolithic silicon wafer). The syringe may be in an automated liquid dispenser, such as is found in commercial spin-coating apparatuses, and may be disposable and/or replaceable. The dropper 12 can be replaced with an automated cartridge or pressure can dispenser. Any of the automated dispensers can be configured to dispense a predetermined volume of the LLZO sol-gel 10 onto the electrode (precursor) layer 22. Once dispensed, the LLZO sol-gel 10 forms a thin layer or coating 14 on the electrode (precursor) layer 22. To facilitate formation of the layer or coating 14, the substrate may be rotated (e.g., using a spin-coating apparatus).

When the thin layer or coating 14 of the LLZO sol-gel completely or substantially completely covers the electrode (precursor) layer 22, the LLZO sol-gel layer or coating 14 is dried (e.g., to remove the solvent[s], any excess water, and any additional volatile components or materials) and calcined to form a LLZO thin film 16 on the electrode layer 22. At the same time, when the electrode or electrode precursor layer 22 is the electrode precursor layer prior to drying and calcining, the electrode precursor layer is converted to the electrode layer.

Drying may comprise heating and/or passing a gas over the layer or coating 14. For example, drying may be conducted at a temperature of 50-150° C. (or any temperature or range of temperatures therein), for a length of time of from 5 minutes to 2 hours (or any length of time or range of lengths of time therein). The gas for drying the layer or coating 14 may be or comprise air, nitrogen, a noble gas such as helium, neon or argon, scuba gas, etc., and may be dried (to remove water vapor) and/or heated (e.g., to a temperature of 50-150° C.) before use. Because the ultimate product is a fully oxidized LLZO thin film, the layer or coating 14 may be dried in air, or by passing air over the layer or coating 14.

Calcining the dried LLZO layer or coating 14 generally comprises heating the LLZO layer or coating 14 to a temperature of from 300° C. to 800° C. (or any temperature or range of temperatures therein), for a length of time of from 1 minutes to 60 minutes (or any length of time or range of lengths of time therein) to form the LLZO film 24. Similar to drying, calcining may be conducted in an oven or furnace, in an atmosphere comprising air, nitrogen, a noble gas such as helium, neon or argon, scuba gas, etc. However, air (which may be dried prior to injection into the oven or furnace) is preferred, for reasons given herein. The length of time for calcining should be sufficient to completely or substantially completely remove all organic and volatile materials from the LLZO, and may be 3 minutes, 5 minutes, 10 minutes or more. To minimize thermal budget concerns, the LLZO layer or coating 14 (together with the electrode or electrode precursor layer 22 and the substrate 20) should be calcined for at most only slightly more than the minimum length of time (e.g., 60 minutes or less, 45 minutes or less, 30 minutes or less, etc.).

In addition, minimizing the calcining time has the advantage of maximizing the amorphous phase of the resulting the LLZO film 24. Preferably, the LLZO film 24 is completely or substantially completely amorphous, although it may contain small areas or volumes (e.g., <10% by area or volume) of tetragonal or cubic LLZO.

After calcining, the LLZO film 24 may have a thickness of 20 nm-3 μm, or any thickness or range of thicknesses therein. In some embodiments, the process depicted in FIG. 1 is repeated until the LLZO film 24 has a desired thickness, or a thickness within a target range (e.g., 300-1000 nm, or any value or range of values therein). Repeated coatings (i.e., coating, drying and calcining processes) may have the advantage of evening out (i.e., making more uniform) the thickness of the LLZO film 24 across the entire substrate 20, but at a disadvantage of time and/or energy consumed.

### Example 1

Amorphous Ta-doped LLZO-based (LLZTO) thin films were fabricated by the sol-gel method, substantially as illustrated in FIG. 1. Metal alkoxides were used as the raw materials (i.e., precursors), including lithium tert-butoxide, zirconium n-propoxide (70 wt. % in n-propanol), and tantalum ethoxide, except that lanthanum nitrate hexahydrate was the lanthanum precursor. A nominal stoichiometric ratio of Li_{6.4}La₃Zr_{1.4}Ta_{0.6}O₁₂ was set for the target composition of the amorphous LLZTO thin films. An additional 20 mol % of lithium t-butoxide was included to compensate for lithium loss during subsequent heating (calcining). The lithium t-butoxide, tantalum ethoxide, and lanthanum nitrate hexahydrate were vigorously stirred for 0.5 h at room temperature in sufficient 2-methoxyethanol to form a homogeneous solution, then the zirconium n-propoxide was added, and the solution was stirred for another 2 h at room temperature. An appropriate amount (>>a molar excess) of deionized (DI) water was introduced for hydrolysis and condensation reactions, under constant stirring for 5 h at room temperature to obtain the final LLZTO sol precursor for the preparation of the thin films.

LLZTO thin films were prepared from the LLZTO sol precursor by the following procedure. 1 wt% of polyvinylpyrrolidone (molecular weight =1,300,000) was added to the LLZTO sol and stirred to form a uniform mixture, and the sol was coated onto a single-crystal Si wafer having a diameter of 2 inches (50 mm) by drip casting. The coated wafer was calcined at 600° C. for 10 min in air. The resultant LLZTO film was uniform and crack-free over the whole surface, with a thickness of 550 nm and a refractive index of 1.5 (as measured by ellipsometry).

FIG. 2 is a reproduction of an image of the LLZTO thin film 30 deposited on the Si wafer (not visible), taken with a mobile phone camera. FIG. 3A is a scanning electron microscope (SEM) image of the LLZTO thin film obtained from the LLZTO sol containing 1 wt % polyvinylpyrrolidone (PVP) as described above. In the scanning electron microscope (SEM) image, the LLZTO film shows a porous microstructure with worm-like pores 45a-c. For comparison, an LLZTO thin film obtained from the LLZTO sol without the polymer additive shows a dense microstructure 50, as can be seen in the SEM image in FIG. 3B.

### Example 2

A LLZTO dense-porous bi-layer electrolyte was prepared by the following procedure. A LiCoO₂ cathode was formed on a stainless steel sheet having a thickness of 75 μm, then was first coated with the LLZTO sol described in Example 1 without the PVP additive, then dried and calcined according to the procedure described in Example 1, thereby forming a dense electrolyte sublayer. The dense LLZTO sublayer was then coated with the LLZTO sol of Example 1 containing the PVP additive and dried and calcined according to the procedure described in Example 1, thereby forming a porous electrolyte sublayer on the dense sublayer. A conductive ACC layer primarily containing copper was then deposited on the porous LLZTO sublayer magnetron sputtering through a shadow mask to form an array of patterned battery cells. The pores at the electrolyte/ACC interface provide a free volume for the formation of a lithium anode during the first charge of the battery cell (which does not include an anode at the time of its formation). The pores in the porous LLZTO electrolyte sublayer significantly improve the cycling performance of the cell (i.e., a much longer cycle life) relative to a similar or otherwise identical electrolyte layer without the porous sublayer. At the same time, the dense electrolyte sublayer prevents any lithium dendrites (which may form during charging) from contacting with the cathode, thereby preventing short circuiting during use.

### Exemplary Methods of Making a Solid-State Battery Cell

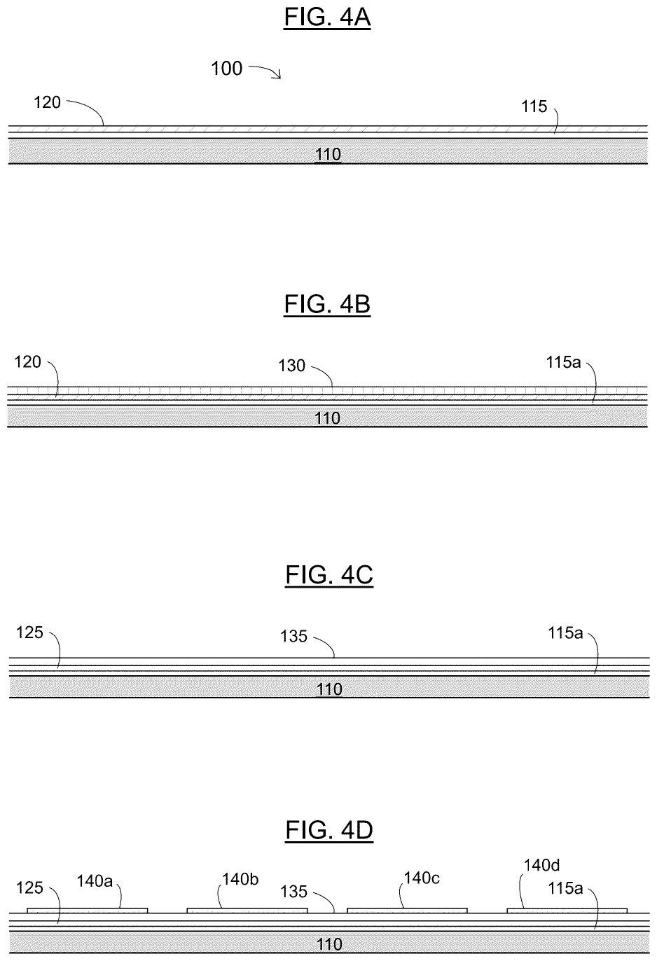

FIG. 4A is a cross-section of cathode precursor-coated substrate 100, comprising a substrate 110 with a barrier layer 115 thereon, coated with a cathode precursor layer 120. In most embodiments, the substrate 110 comprises a metal foil, which may comprise or consist essentially of stainless steel, aluminum, copper, nickel, inconel, brass, molybdenum or titanium some examples, the elemental metals of which may be alloyed with up to 10% of one or more other elements to improve one or more physical and/or chemical properties thereof (e.g., oxygen and/or water permeability, flexibility, resistance to corrosion or chemical attack during subsequent processing, etc.). However, the substrate 110 can also be a metal sheet or metal roll. For example, the metal foil or film may be 10-100 μm thick, whereas a metal sheet or roll may have a thickness of >100 μm, up to about 1-2 mm, although the invention is not so limited. Other alternative substrates include a metal coating on a mechanical substrate, such as aluminum, copper, nickel, titanium, etc., on a ceramic sheet or plate.

The substrate 110 may further include a barrier 115 that comprises one or more layers of one or more materials in a thickness effective to prevent migration of atoms or ions from the metal foil, sheet or film into overlying layers. The barrier material(s) may comprise an electrically conductive material, such as a (refractory) metal nitride (e.g., aluminum nitride, titanium nitride, titanium aluminum nitride, tungsten nitride, titanium tungsten nitride, TiW alloy, tantalum nitride, etc.), or a glass or ceramic, such as silicon dioxide, aluminum oxide, silicon nitride, a silicon and/or aluminum oxynitride, etc. Some embodiments include first and second barriers, such as alternating glass/ceramic and metal nitride layers (e.g., a first metal nitride layer, a first glass/ceramic layer, and a second metal nitride layer, which may further comprise a second glass/ceramic layer, a third metal nitride layer, etc.). The barrier 115 may have a total thickness of 0.5-3μm, but the barrier 115 is not limited to this range. The barrier 115 may be blanket-deposited onto the substrate 110 by chemical or physical vapor deposition (e.g., sputtering, thermal evaporation, atomic layer deposition [ALD], etc.), solution-phase coating with a precursor material followed by annealing to form the glass/ceramic or metal nitride (which may result in the barrier effectively coating all surfaces of the substrate), etc. Exemplary barrier materials, structures and thicknesses and methods for their deposition are disclosed in U.S. Pat. Nos. 9,299,845 and 11,742,363, the relevant portions of each of which are incorporated by reference herein.

The cathode precursor layer 120 may comprise a lithium metal oxide or precursor thereof, such as a lithium-transition metal oxide (e.g., LiMO₂, M=Co, Ni or Mn, such as lithium cobalt oxide [LiCoO₂; LCO]) and lithium manganese oxide [LiMn₂O₄; LMO]), a layered lithium-transition metal oxide (e.g., Li_{4/3-x}Ni²⁺ₓMn⁴⁺_{2/3-x}Co³⁺ₓO₂, sometimes termed “Li-rich NMC”), or a fully-oxidized lithium-transition metal compound for cathodes, such as lithium iron phosphate (LiFePO₄; LFP) or a nickel-manganese-cobalt oxide (NMC, which may include Li-rich NMCs and others). Alternatively, the cathode precursor layer 120 may be replaced with an anode or anode precursor layer (e.g., Li₄Ti₅O₁₂).

The cathode precursor layer 120 may be deposited by coating (e.g., using a sol-gel). Alternatively, the cathode precursor layer 120 deposited (selectively in some cases) by screen printing, inkjet printing, spray coating, or extrusion coating using an ink comprising one or more sol-gel precursors analogous to those described herein for the LLZO electrolyte film and one or more solvents, having a viscosity appropriate for the printing or coating technique. In yet further alternatives, the cathode precursor layer 120 may be blanket deposited by laser deposition (e.g., pulsed laser deposition or PLD), sputtering, chemical vapor deposition (CVD), sol-gel processing, etc.

Referring now to FIG. 4B, the LLZO sol-gel layer 130 is deposited (e.g., by coating) onto the cathode precursor layer 120, as described herein. In the embodiment(s) shown in FIGS. 4A-C, the LLZO sol-gel layer 130 and the cathode precursor layer 120 are simultaneously converted to a cathode 125 and an LLZO electrolyte 135 by calcining, as described herein.

In various embodiments, calcining comprises heating or annealing in an oven or furnace. For example, during such heating or annealing, the temperature of the oven or furnace may be ramped up at a rate of x ° C./min from room temperature to y ° C. For example, x may be a number in the range of 10-50° C./min, or any value or range of values therein (e.g., 20° C./min), and y may be a number in the range of 500-800° C., or any value or range of values therein (e.g., 550-650° C., 600° C., etc.). The final temperature of y ° C. may be maintained for 1-60 minutes, as described herein, before cooling back to room temperature. Meanwhile, an oxygen-containing gas such as clean dry air (CDA) may flow through the oven or furnace at a rate in the range of 1-25 standard cubic feet per hour (SCFH), 2-50 standard liters per minute (SLPM), or any value or range of values therein (e.g., 5-15 SCFH, 10 SCFH, 10-30 SLPM, etc.). The gas flow rate may depend on the dimensions of oven or the furnace and the samples to be annealed, and may be optimized based on (i) the size and shape of the furnace and the samples and (ii) the quantity of the samples. Alternatively, clean “moist” (undried) air, scuba gas, or oxygen may flow through the oven or furnace instead of CDA.

FIG. 4D shows a number of anode current collectors (ACCs) 140a-d on the LLZO electrolyte 135, thus forming substantially complete (but unsealed) cells. A separately-formed anode is not necessary in solid-state lithium batteries, as a lithium anode can be formed between the LLZO electrolyte 135 and the anode current collectors 140a-d during charging, if necessary. Optionally, however, a thin lithium anode can be deposited by evaporation onto the LLZO electrolyte 135 prior to formation of the anode current collectors 140a-d.

The anode current collectors 140a-d generally comprise a conductive metal, such as nickel, zinc, copper, alloys thereof (e.g., NiV), etc., or another conductor, such as graphite. The anode current collectors 140a-d can be selectively deposited by screen printing, inkjet printing, spray coating, etc., or formed by blanket deposition (e.g., sputtering or evaporation) and patterning (e.g., low-resolution photolithography, development and etching). The anode current collectors 140a-d may have a thickness of 0.1-5 μm, although it is not limited to this range.

The anode current collectors 140a-d may have area dimensions (i.e., length and width dimensions) that are 50-95% of the corresponding length and width dimensions, respectively, of the solid-state battery cell, although the borders of the anode current collectors 140a-d are generally offset (pulled back) a minimal distance from the ultimate cell borders, in some embodiments. The pull-back distance of the ACCs 140a-d from the cell edges should be sufficient to electrically isolate the ACCs 140a-d from the CCC/substrate 100, if necessary.

The cells may further include one or more interlayers that modify the interfaces between layers. For example, an amorphous (e.g., elemental silicon) interlayer may be deposited on the LLZO electrolyte 135 prior to formation of the anode current collectors 140a-d to inhibit reduction of the electrolyte. Additionally, a metal oxide (e.g., Nb₂O₅, Al₂O₃, Li₄Ti₅O₁₂ or LiNbO₃) interlayer may be formed on the cathode 125 prior to deposition of the LLZO sol-gel 130 to reduce interfacial stress, decrease interfacial resistance, or suppress formation of a space charge layer, although such an interface layer is unnecessary in the present invention. Of course, the battery cell can be made in the reverse order (i.e., the anode current collector may be first formed on the substrate, then the remaining layers deposited in reverse order thereon, in which case the metal oxide interface layer between the LLZO electrolyte and the cathode may be more advantageous).

From the structure shown in FIG. 4D, the battery cells can be singulated, routed for electrical connection to terminals on/in the packaged battery (as needed), and packaged as described in U.S. Pat. Appl. Publ. Nos. 2024/0128498, 2023/0378606, 2023/0420731 and 2024/0113341, and in U.S. patent application Ser. Nos. 18/925,892, 18/925,267, 18/640,416 and 18/946,887 (Attorney Docket Nos. IDR2022-01, IDR2022-02, IDR2022-03, IDR2022-04, IDR2022-07, IDR2022-08, IDR2022-09 and IDR2022-10), the relevant portions of which are incorporated herein by reference.

An advantage of the present method of manufacturing battery cells is that some/all of the active battery layers (e.g., the cathode 120 and the solid-state electrolyte 130) can be deposited as blanket layers. This maximizes the active area utilization of the battery cells for high intrinsic capacity, and also results in a topographically planar or “flat” cell to facilitate formation of the uppermost layer(s) and downstream packaging due to the pattern-free blanket-deposited layers. However, if necessary or desired, the cathode 125 and the LLZO electrolyte 135 can be slightly pulled back from the cell edge by subtractive patterning (e.g., low-resolution photolithography, laser ablation) or selective deposition (as described herein).

Alternatively, the ACCs 140a-d, the LLZO electrolyte 135 and the cathode 120 may be patterned such that one or more exposed pads or tabs extend from the cathode 120 and are not covered by any of the ACCs 140a-d or the LLZO electrolyte 135. This allows for electrical connection of a terminal in the packaged battery to the cathode 120, in the event that the substrate 110 is not electrically conducting, or there is no ohmic connection between the cathode 120 and an electrically-conductive substrate 110.

### Example 3

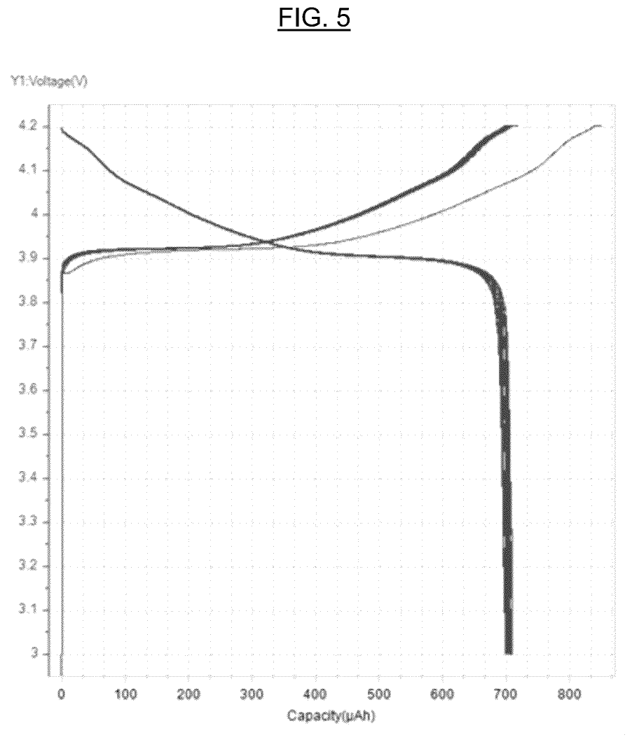

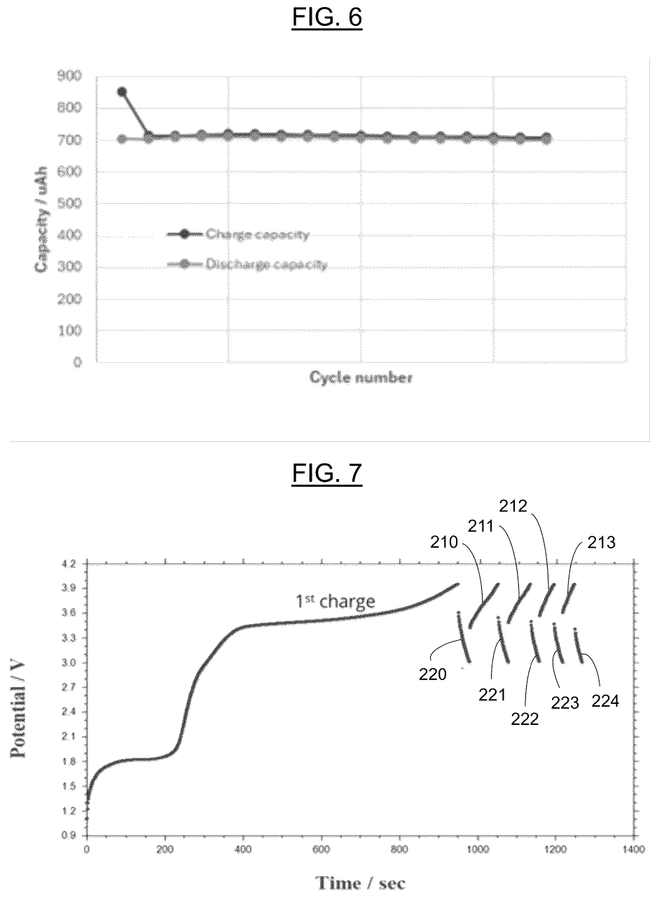

A solid-state battery a half-cell was formed from a LiCoO₂ thin film on a conductive 75-μm thick stainless steel sheet substrate, in which the LiCoO₂ thin film was coated with a LLZTO thin film as described in Example 1. The LLZTO thin film had a thickness of 250 nm. Charge/discharge cycling performance of the half-cell was measured at a rate of C/2 (where C is the capacity of the battery, and the rate is in hours), at room temperature, in 1 M LiClO₄ in a 1:1 by volume mixture of propylene carbonate (PC)-dimethyl carbonate (DMC). FIG. 5 shows a graph of the voltage of the half-cell as a function of charge capacity for 17 cycles, and FIG. 6 is a graph showing the charge capacity and discharge capacity of the half-cell for each cycle. Except for the charging phase of the initial cycle, the cycling performance of the half-cell is repeatable and remarkably consistent. Thus, the half-cell with the exemplary LLZTO electrolyte exhibits the full capacity of the LiCoO₂ cathode with excellent cycling reversibility, indicating that the sol-gel electrolyte layer possesses very high Li-ion conductivity.

### Example 4

A prototype cell was built using a 2-μm-thick sol-gel LLZTO layer as the electrolyte as described in Example 1, on a LiCoO₂ thin film cathode as described for Example 2. The LiCoO₂ cathode was formed on 75-μm stainless steel sheet as described in Example 2. The stainless steel sheet also functioned as a cathode current collector (CCC). A conductive ACC primarily containing copper was deposited on the LLZTO layer electrolyte by sputtering. The cell was charged and discharged (5 cycles) at a constant current of 50 μA between 3.95 V and 3 V. Curves 210-213 respectively show the battery potential as a function of time for the second through fifth charge cycles, and curves 220-224 respectively show the battery potential as a function of time for the first through fifth discharge cycles. The plot in FIG. 7 shows the cell is cyclable.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated.

1. A method of making a lithium lanthanum zirconium oxide (LLZO) thin film, comprising:
forming a LLZO sol and/or gel from a lithium precursor, a lanthanum precursor, a zirconium precursor, one or more solvents, water, and an optional dopant, and
converting the LLZO sol and/or gel to the LLZO thin film.

2. The method of claim 1, wherein forming the LLZO sol and/or gel comprises preparing a LLZO sol-gel precursor solution, and the method further comprises coating the LLZO sol-gel precursor solution directly on a substrate prior to converting the LLZO sol and/or gel to the LLZO thin film.

3. The method of claim 2, wherein coating the LLZO sol-gel precursor solution comprises drip casting, spin coating, or dip coating the LLZO sol-gel precursor solution onto the substrate, resulting in the LLZO sol and/or gel on the electrode layer.

4. The method of claim 2, wherein the substrate comprises a metal sheet, foil or film with a cathode layer thereon.

5. The method of claim 2, wherein converting the LLZO sol and/or gel to the LLZO thin film comprises heating, annealing or calcining the LLZO sol and/or gel at a temperature of 300° C. to 800° C. to form the LLZO thin film.

6. The method of claim 1, wherein the LLZO thin film is completely or substantially completely amorphous, and contains <10 % by area or volume of tetragonal or cubic LLZO.

7. The method of claim 1, wherein the LLZO film has a thickness of 20 nm-3 μm.

8. The method of claim 1, wherein forming the LLZO sol-gel comprises mixing the lithium precursor, the lanthanum precursor, the zirconium precursor, the one or more solvents, and the optional dopant in a mixing vessel in one or more steps to form a homogeneous mixture of the lithium precursor, the lanthanum precursor, the zirconium precursor, the one or more solvents, and the optional dopant, and hydrolyzing the homogeneous mixture.

9. The method of claim 8, wherein hydrolyzing the homogeneous mixture comprises adding a molar excess of water and a catalyst to the homogeneous mixture, and mixing the homogeneous mixture, the water and the catalyst until hydrolysis is substantially complete.

10. The method of claim 5, wherein converting the LLZO sol and/or gel to the LLZO thin film further comprises drying the LLZO sol and/or gel to remove the one or more solvents, any excess water, and any additional volatile components or materials in the LLZO sol and/or gel prior to heating, annealing or calcining the LLZO sol and/or gel.

11. The method of claim 1, wherein:
the lithium precursor comprises a lithium halide, a lithium pseudohalide, a lithium alkoxide, a lithium aralkoxide, a lithium alkylcarboxylate, a lithium aralkylcarboxylate, a lithium alkylthiolate, or a lithium aralkylthiolate that is soluble in the one or more solvents;
the lanthanum precursor comprises a lanthanum halide, a lanthanum pseudohalide, a lanthanum alkoxide, a lanthanum alkylcarboxylate or a lanthanum diketonate compound that is soluble in the one or more solvents;
the zirconium precursor comprises a zirconium halide, a zirconium pseudohalide, a zirconium alkoxide, a zirconium alkylcarboxylate or a zirconium diketonate compound that is soluble in the one or more solvents; and
the one or more solvents comprise an organic solvent or organic solvent mixture that uniformly and/or homogeneously dissolves the lithium precursor, the lanthanum precursor, and the zirconium precursor.

12. The method of claim 1, wherein the dopant is present and comprises a source of aluminum (Al), gallium (Ga), indium (In), niobium (Nb), tantalum (Ta), vanadium (V), antimony (Sb), hafnium (Hf), or another lanthanide selected from cerium (Ce), neodymium (Nd) and ytterbium (Yb), and is present in a molar ratio with respect to zirconium atoms of from 0.01:1 to 1:1.

13. A method of making a solid-state battery cell, comprising:
forming an electrode on an electrically conductive metal-containing substrate,
coating the electrode with a lithium lanthanum zirconium oxide (LLZO) sol and/or gel,
converting the LLZO sol and/or gel to a LLZO thin film, and
depositing a counter-electrode or counter-electrode current collector on the LLZO thin film.

14. The method of claim 13, wherein the substrate comprises a metal foil or film having a thickness of 10-100 μm.

15. The method of claim 13, wherein the electrode comprises a lithium metal oxide cathode layer.

16. The method of claim 15, wherein forming the lithium metal oxide cathode layer comprises depositing a cathode precursor layer on the substrate, the cathode precursor layer comprises a lithium metal oxide or precursor thereof, and converting the LLZO sol and/or gel to the LLZO thin film simultaneously converts the cathode precursor layer to the lithium metal oxide cathode layer and the LLZO sol and/or gel to a LLZO electrolyte.

17. The method of claim 13, wherein converting the LLZO sol and/or gel to the LLZO thin film comprises heating or annealing or calcining the LLZO sol and/or gel in an oven or furnace at a temperature of 500-800° C. for 1-60 minutes.

18. The method of claim 16, wherein the counter-electrode or counter-electrode current collector comprises an anode current collector (ACC), and depositing the ACC comprises screen printing, inkjet printing, spray coating, or blanket deposition and patterning a conductive elemental metal or metal alloy anode film.

19. A solid-state battery cell, comprising:
an electrically conductive metal-containing substrate;
an electrode on the substrate, and
a doped or undoped lithium lanthanum zirconium oxide (LLZO) electrolyte on the electrode, and
a counter-electrode or counter-electrode current collector on the LLZO electrolyte.

20. The solid-state battery cell of claim 19, wherein the LLZO electrolyte is amorphous, contains <10 % by area or volume of tetragonal or cubic LLZO, and has a thickness of 20 nm-3 μm.
